(19) United States
(12) Patent Application Publication
(10) Pub. No.: US 2004/0025454 A1
(43) Pub. Date: Feb. 12, 2004

(54) Window frames

(76) Inventor: Norman Burgess, Sible Hedingham Essex (GB)

Correspondence Address: PIPER RUDNICK, P. O. BOX 64807, CHICAGO, IL, 60664-0807, US

(21) Appl. No.: 10/363,764

(22) PCT Filed: Sep. 5, 2001
(86) PCT No.: PCT/GB01/03997

(30) Foreign Application Priority Data
Sep. 5, 2000 (GB) 00217620
Jun. 14, 2001 (GB) 01145457

(51) Int. Cl. E06B 1/04; E04C 2/38

(52) U.S. Cl. 52/204.1; 52/656.5

(57) ABSTRACT

A window frame section 100 comprises a central portion 10 of a thermally-insulating material and inner and outer sections 20, 30 of a different material, such as steel, the central portion 10 being produced by extrusion or pultrusion and incorporating projections and channels for receiving glazing units, beads and hardware fixings. The inner and outer faces of portion 10 have angled ends 12, 14, 17, 19 for the attachment of the sections 20, 30. Portion 10 may be hollow and may comprise a plurality of hollow channels. Portions 20, 30 may be attached to central portion 10 by retaining pins.

The present invention relates to frames for windows and glazed doors.

Existing window frames can be manufactured using various metals. Aluminium is widely used since it has the advantages that only a relatively small thickness is required, that it can be used in tubular sections and that thermal breaks can be easily provided. Cold formed steel can also be used; narrow gauge material is bent into shape and thermal breaks can also be provided.

Existing window frames made from hot rolled steel, including stainless steel, have no provision for a thermal break.

The present invention seeks to provide a window frame having a high thermal performance. The present invention also seeks to provide a window frame which supplies a wide range of options for the materials of the inner and outer faces of the frame which are visible after installation.

EP 0085775 discloses windows and door frames with a thermally insulating member between two metal profile elements. However, the metal profile elements have a relatively complicated cross-section since they define channels for accommodating retaining means for glazing units.

According to the present invention, there is provided a window frame having a cross-section with a central portion of a thermally-insulating material with sections of a different material attached to the inner face and to the outer face of the central portion, characterised in that the central portion has one or more channels for accommodating retaining means for a glazing unit.

An advantage of the above arrangement is that the inner and outer sections can have a simple cross-section and can be easily and relatively cheaply produced, e.g. by rolling. Such a frame is also easy to assemble.

The central portion is preferably an extruded or pultruded section of glass fibre-reinforced polyester or phenolic resin profile material. This means it is relatively easy to manufacture the central portion with all the projections and channels required to accommodate glazing units, beads and hardware fixings.

The central portion may be hollow and may comprise a plurality, e.g. three, of hollow channels.

The inner and outer sections are preferably of stainless steel or carbon steel. Alternatively, they may be of aluminium, wood or PVC U. The inner section on a window frame may be of the same material as, or a different material from, the material of the outer section on the same window frame.

The inner and outer exterior may incorporate U-shapes which fit over the end regions of the central portion. The ends of the U-shapes may be separated by gaps from the end regions of the central portion.

Preferred embodiments of the present invention will now be described, by way of example only, with reference to the accompanying drawings, of which:

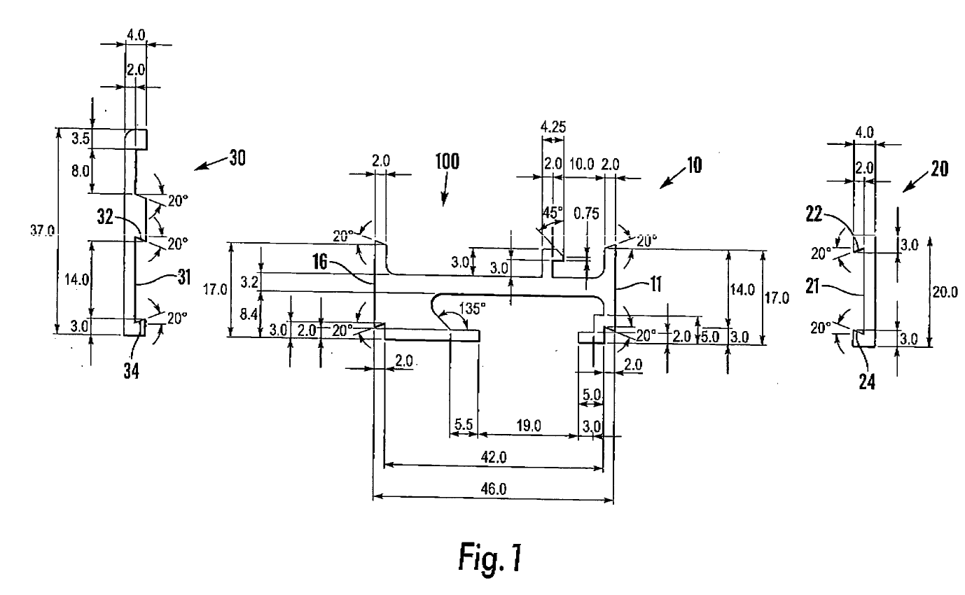

FIG. 1 shows an exploded cross-sectional view on an enlarged scale of a fixed light window frame in accordance with a first embodiment of the present invention;

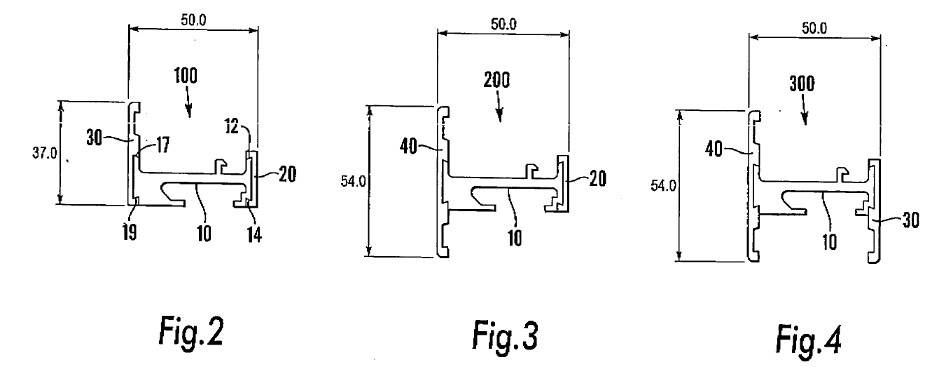

FIG. 2 shows the embodiment of FIG. 1 after assembly;

FIGS. 3 and 4 show fixed light window frames with modified facia sections.

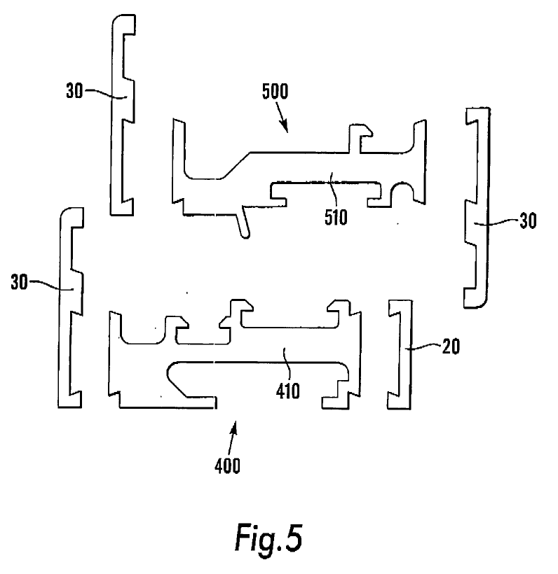

FIG. 5 shows an exploded cross-sectional view on an enlarged scale of an opening window frame within an outer fixed window frame in accordance with a second embodiment of the present invention;

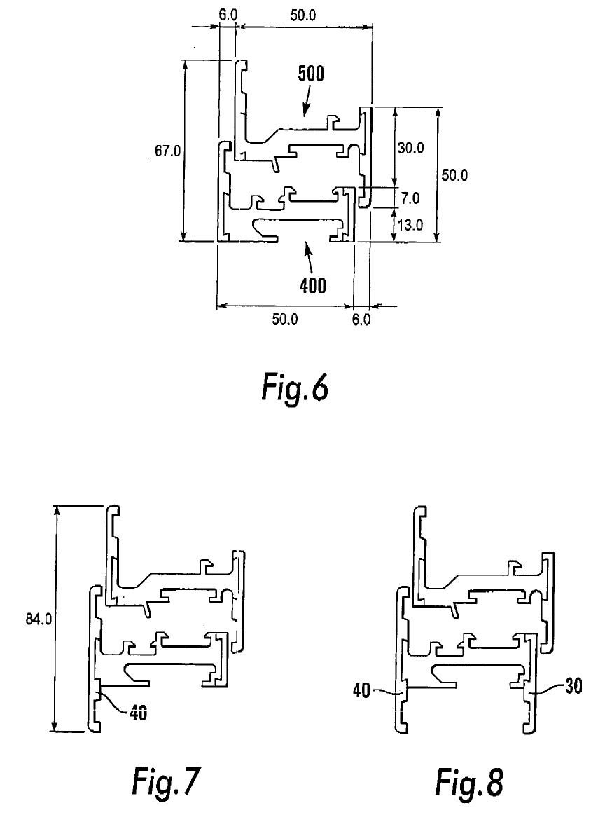

FIG. 6 shows the embodiment of FIG. 5 after assembly;

FIGS. 7 and 8 show opening window frames with modified facia sections;

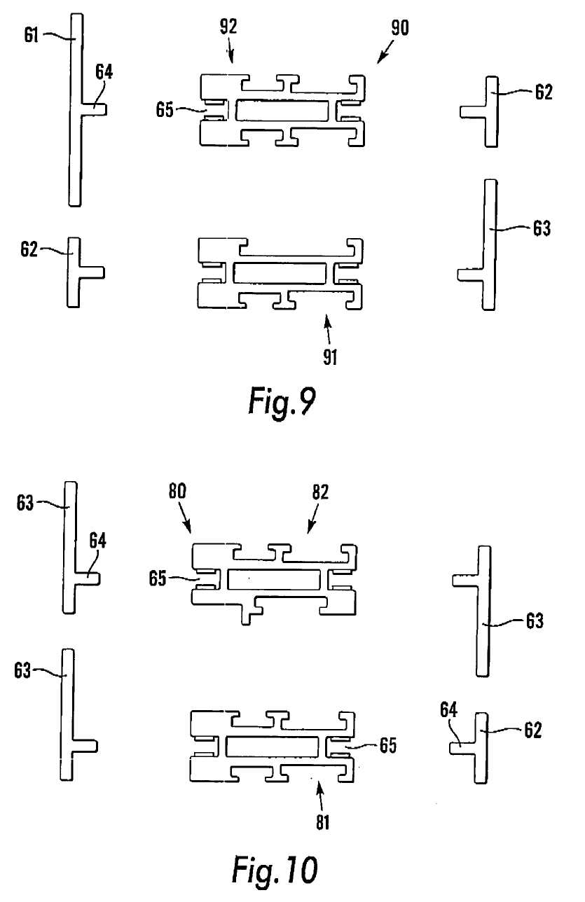

FIG. 9 shows a view corresponding to FIG. 5 of the parts of a glaze in, open out window frame in accordance with a third embodiment of the present invention;

FIG. 10 shows a view corresponding to FIG. 5 of the parts of a glaze in, open in window frame in accordance with a fourth embodiment of the present invention;

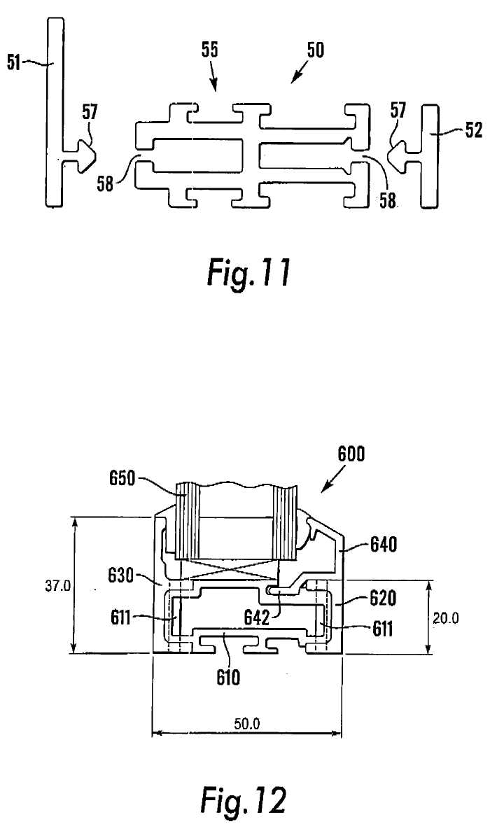

FIG. 11 shows a view corresponding to FIG. 1 of a glaze in, fixed light window frame in accordance with a fifth embodiment of the present invention;

FIG. 12 shows a cross-section view of a glaze in fixed light window frame according to a sixth embodiment of the present invention;

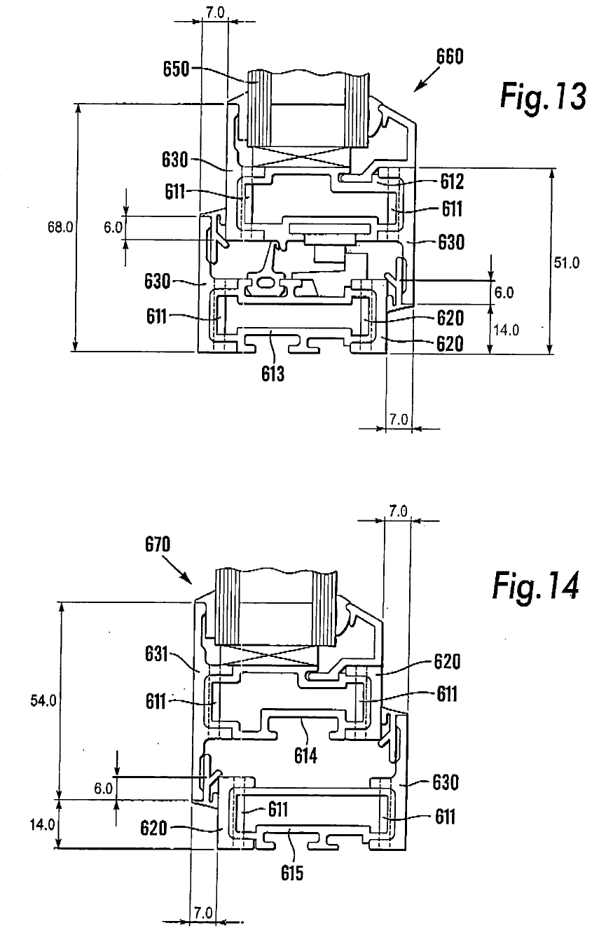

FIG. 13 shows view corresponding to FIG. 12 of a glaze in open in arrangement in accordance with a seventh embodiment of the present invention;

FIG. 14 shows a view corresponding to FIG. 12 of a glaze in open out arrangement in accordance with an eighth embodiment of the present invention; and

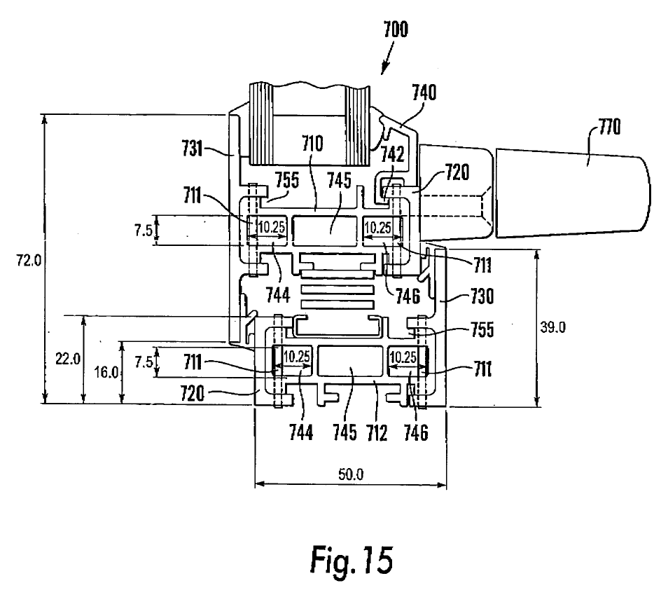

FIG. 15 shows a cross-sectional view of a glaze in open out window frame arrangement according to a ninth embodiment of the present invention.

Preferred dimensions in mm are given in the Figures.

Referring to the drawings, FIG. 1 shows three parts of a window-frame section 100, namely a central portion 10 and inner and outer portions 20 and 30. Preferred dimensions of the various parts of portions 10, 20 and 30 are given in millimetres in FIG. 1.

Central portion 10 is made of a thermally-insulating synthetic material such as a glass-reinforced profile of polyester/phenolic resin material. It is of extruded or pultruded material and is manufactured with the various projections and channels necessary to accommodate the glazing units and beads and to fit in the surrounding aperture in a building wall. Portion 10 has an inner face part 11 with ends 12, 14 which are angled at 20° in the manner of a dove-tail joint. Similarly, outer face part 16 has angled ends 17 and 19.

Inner frame portion 20 has a thickness of 2 mm and is of stainless steel prepared from a solid shape by means of a hot rolling and cold drawing process. It has a channel 21 which has angled ends 22, 24 and is arranged to slide on to face part 11 of portion 10 to be fixedly attached thereto.

Outer frame portion 30 also has a thickness of 2 mm and is made of the same material as portion 20. It, too, has a channel 31 with angled ends 32, 34 which engage with the ends 17, 19 of face part 16 to fixedly attach portion 30 to portion 10.

The assembled window-frame section is shown in FIG. 2. To form a frame, lengths of the composite section are connected at the corners by welding or by means of adhesive or mechanical fixings.

The above described window frame has numerous advantages. For example, the material of portion 10 gives considerable strength to the window frame. Moreover, all the projections and channels are provided on the portion 10, so that the steel sections 20 and 30 have shapes which are simple to produce by rolling. A thermal break is provided by portion 10, while allowing the window to have the internal and external appearance of stainless steel which is attractive and does not corrode. Alternatively, it can be readily coated with polyester powder. Moreover, the steel sections are relatively narrow, so that the window has good sight-lines.

Use of such window frames also provides greater flexibility in shape and finish. For example, the portions 20 and 30 may be of any desired material such as carbon steel, aluminium or another metal or alloy, wood, plastics material such as PVC, and the portions on a single frame may be of a different material and/or colour.

Various modifications may be made to the above-described embodiment to cater for different applications. For example, FIG. 3 shows a fixed window frame with a longer outer portion 40 instead of portion 30. Alternatively, as shown in FIG. 4, a longer outer portion 40 is combined with an inverted portion 30 on the inside instead of portion 20.

Portions 20, 30 and 40 may be arranged to snap onto faces 11 and 16 of portion 10 rather than to slide thereon.

The window frame section can also be used in opening windows as illustrated in FIGS. 5 to 8 which show open out vents. FIG. 5 shows the parts of a fixed window frame section 400 and a relatively movable window frame section 500. In similar fashion to window frame section 100 of FIG. 1, section 400 comprises a thermally-insulating central portion 410 and inner and outer stainless steel portions 20 and 30. Section 500 also comprises a thermally-insulating portions 510 and two stainless steel portions 30. Again the central portions 410, 510 and manufactured with all the shaped projections to receive the glazing units and the seals and to engage the surrounding aperture in the building wall.

FIG. 6 shows the assembled window frame sections 400, 500 of FIG. 5 in their installed disposition.

Modified assemblies are possible, e.g. FIG. 7 shows an opening window-frame in which the steel portion 30 of section 400 is replaced by a longer outer portion 40. Alternatively in the modification of FIG. 8, section 400 is further modified in that it has a longer inner portion 30 instead of portion 20.

In general, the same modifications may be made to the window frame sections of FIGS. 5 to 8 as mentioned in connection with FIGS. 1 to 4.

For all the described embodiments, the dimensions are given only as examples preferred thickness of the portions 20, 30 and 40 lie in the range 1.5 mm to 3 mm and the preferred angles of the ends 12, 14, 17, 19, 22, 24, 32, 34 lie within the range of 15° to 30°.

The various embodiments of the invention permit a flexible design process. It will be noted that only three differently-shaped steel portions 20, 30 and 40 are required to provide a wide range of options. If windows of a different thickness are required, e.g. to increase the separation of the glazing sheets, it is relatively simple to vary the size of the extruded/pultruded portion 10, 410, 510.

Window frames with a large range of portions 20, 30, 40 of different materials and colours may be supplied to a site, to permit the finish to be selected as late as possible in the design process.

Glazed doors may also be provided with similar frame sections.

FIG. 9 shows a window frame section 90 in accordance with third embodiment of the present invention comprising a fixed frame section 91 and a relatively movable frame section 92. FIG. 10 shows a window frame section 80 in accordance with a fourth embodiment of the present invention comprising a fixed frame section 81 and a relatively movable frame section 82. Again the frame sections comprise thermally-insulating central portions and inner and outer stainless steel sections 61, 62, 63. The sections 61, 62, 63 and the central portions are attached by pushing them together so that projections 64 enter grooves 65. They are then secured with adhesive. At the corners of the frames, the various components are secured together by pinning.

In a modification, frame section 81 serves for a fixed light window.

FIG. 11 shows a fixed light window frame section 50 in accordance with a fifth embodiment of the present invention comprising a thermally-insulating central portion 55 and stainless steel portions 51, 52. The portions 51, 52 are attached to the central portion by arrowhead protrusions 57, which enter slots 58.

The features and modifications of the embodiments of FIGS. 9 to 11 may be exchanged with those of FIGS. 1 to 8 as appropriate.

FIG. 12 shows a glaze in fixed light frame section 600 comprising a central portion 610 of insulting material and inner and outer steel portions 620, 630. A bead 640 fits into one of the channels formed in portion 610 t assist in retaining a glazing unit 650. The portions 620, 630 comprise U-shapes for fitting snugly over the inner and outer end regions of central portion 610. They are assembled simply by being pushed on. To ensure that portions 620, 630 remain permanently attached to central portion, a hole is made extending completely through the arms of the U-shapes and the end region of portion 610, and a mechanical retaining pin 611 is then driven into the hole. These holes are provided at the ends of each side of the window frame and also at a central region of each side.

Since central portion 610 is hollow, it requires less material for the same rigidity and is lighter. In addition, pins 611 prevent unauthorised removal of the inner and outer portions 620, 630.

FIGS. 13 and 14 respectively show open in and open out arrangements 660, 670 employing similar frame components to FIG. 12, but using central portions 612, 613, 614 and 615 having differing cross-sectional shapes. The embodiment of FIG. 14 also incorporates an outer portion 631 of a different shape.

FIG. 15 shows a glaze in open out frame section 700 comprising insulating central portions 710, 712 with respective inner and outer steel portions 720, 731 and 730, 720. As with the embodiments of FIGS. 12 to 14, the inner and outer portions are attached to the central portions by mechanical retaining pins 711. The sections 710, 712 each comprise three separate enclosed channels 744, 745, 746. An operating handle 770 is also provided.

It will be noted that in this embodiment, the arms of the U-shapes of the portions 720, 730, 731 overhang the end regions of the central portions to form gaps 755. This means that there is a reduced area of contact between the central portions and the steel portions as compared to the previous embodiments, leading to improved thermal performance.

It will also be noted that the end 742 of bead 740 is bent back, into the adjacent gap 755, in the form of a U-shape. This contrasts with the corresponding arm 642 of the bead 640 of the preceding embodiment.

The embodiment of FIG. 15 shares the advantages of the previous embodiments and has additional advantages. In addition, its thermal performance is improved by having a central portion with three longitudinal hollow sections 744, 745, 746, which reduces thermal conduction between inside and outside the window and which also reduces the effects of thermal convection within the central portion. The reduced areas of contact between the end regions of the central portion and the inner and outer portions also serve to reduce thermal conduction. Bending back the arm 742 of bead 740 also reduces the amount by which bead 740 extends across the width of the window and thus also serves to reduce unwanted transfer of heat.

The features of the various embodiments described above may be combined or interchanged as desired.

1. A window or glazed door frame (100, 500, 90, 80, 50, 600, 660, 670, 700) having a cross-section with a central portion (10, 410, 510, 91, 92, 81, 82, 55, 610, 612-615, 710, 712) of a thermally-insulating material with sections (20, 30, 40; 61, 62, 63; 51, 52; 620, 630, 631; 720, 730, 731) of a different material attached to the inner face and to the outer face of the central portion, characterised in that the central portion has one or more channels for accommodating retaining means (640) for a glazing unit (650).

2. A frame according to claim 1, wherein the sections are arranged to be pushed on to the central portion.

3. A frame according to claim 1 or 2, wherein the central portion is of glass fibre-reinforced polyester or phenolic resin profile material.

4. A frame according to any preceding claim, wherein the sections are of metal.

5. A frame according to claim 4, wherein the metal is steel.

6. A frame according to claim 5, wherein the steel is coated with polyester powder.

7. A frame according to any preceding claim, wherein the central portion is hollow.

8. A frame according to claim 7, wherein the central portion comprises a plurality of enclosed channels.

9. A frame according to any preceding claim, wherein end regions of the central portion and parts of the inner and outer sections are provided with adjacent holes for mechanical retaining pins (611, 711).

10. A frame according to any preceding claim, wherein the inner and outer sections have parts which overhang adjacent regions of the central portion to form gaps (755).

11. A window or glazed door comprising one or more frames according to any preceding claim.

12. A window or glazed door according to claims 10 and 11 and further comprising beads (740) which are shared to each have a part which is arranged to be located in a respective one of the gaps (755).
